(19) United States
(12) Patent Application Publication
(10) Pub. No.: US 2005/0253502 A1
(43) Pub. Date: Nov. 17, 2005

(54) Optically enhanced nanomaterials

(75) Inventor: Halit S. Gokturk, Mountain View, CA (US)

Correspondence Address: GREENBLUM & BERNSTEIN, P.L.C., 1950 ROLAND CLARKE PLACE, RESTON, VA, 20191, US

(73) Assignee: Matsushita Electric Works, Ltd., Osaka (JP)

(21) Appl. No.: 10/843,382

(22) Filed: May 12, 2004

(51) Int. Cl. H01S 3/00; H01J 1/62

(52) U.S. Cl. 313/503

(57) ABSTRACT

An optically enhanced nanomaterial comprising at least one host material having an optical spectrum outside of the visible spectrum from about 400 nm to about 700 nm, and at least one alkali metal dopant adjusting the optical spectrum of the host material. The incorporation of dopant into the host material of the present invention provides optically enhanced nanomaterials that have at least one transition in the visible spectrum. The optically enhanced nanomaterials of the present invention are suitable for use in applications such as light emitting diodes and solar cells. This abstract is neither intended to define the invention disclosed in this specification nor intended to limit the scope of the invention in any way.

### BACKGROUND OF THE INVENTION

1. Field of the Invention

The present invention relates to optically enhanced nanomaterials comprising at least one host material having an energy gap such that its optical spectrum is outside of the visible spectrum (from about 400 nm to about 700 nm), and at least one alkali metal dopant. The present invention also relates to methods of preparing optically enhanced nanomaterials, and methods of using the optically enhanced nanomaterials such as light emitting diodes and solar cells.

2. Discussion of Background Information

Optical properties of nanomaterials incorporated with dopants have been investigated in the past. Semiconductor nanocrystals combine the physical and chemical properties of molecules with the optoelectronic properties of semiconductors. Shim, M. and Phillipe G.-S., G.-S., n-Type Colloidal Semiconductor Nanocrystals, Nature, 47: 981-983 (2000). Conventional doping by introducing impurity atoms has been unsuccessful because the impurities tend to be expelled from the small crystalline cores, and thermal ionization of the impurities is hindered by strong confinement. Shim describes the use of electron transfer to make n-type nanocrystals that show absorption at 0.3 eV. However, this technique is limited because the long term stability of the n-type nanocrystal is affected by the presence of impurities, exposure to air, the dryness of solution, and the temperature.

Another method describes potassium doping by reversibly intercalating and de-intercalating potassium. Bockrath et al., Chemical Doping of Individual Semiconducting Carbon Nanotube Ropes, Physical Review 61: 10606-10608 (2000). The method involves vacuum evaporation from a heated alkali source. The undoped semiconducting nanotubes are doped by molecular species that are adsorbed from the air, and can be removed by heating in vacuum.

Another method describes intercalation of lithium by electrochemically reacting the lithium using a two-electrode cell with lithium foil and open single-wall carbon nanotubes. Shimoda H., et al., Lithium Intercalation into Opened Single Wall Carbon Nanotubes: Storage Capacity and Electronic Properties, Physical Review Letters, 88(1): 015502 (Jan. 7, 2002).

Acker et al., Synthesis of Silicon Nanoclusters by Solid Gas Reaction, 12(21): 1605 (Nov. 2, 2000) describes a method of making silicon nanoclusters with sodium.

Komoda et al., Control of Mechanisms for Room Temperature Visible Light Emission from Silicon Nanostructures in SiO₂ Formed by Si⁺ ion Implantation, Mat. Res. Soc. Symp. Proc. 358: 163 (1995) describes photoluminescence as a result of the effects of quantum confinement of Si nanocrystals in the oxide and dependence on the presence of irradiation induced defects or Si/SiO₂ interface states.

Brown, C., ST Lights up Silicon LED for CMOS Fab Lines, Electronic Engineering Times, www.eetimes.com/story/OEG20021029S0027 (Nov. 4, 2002) describes a method of producing nanoparticles of Si by chemical vapor deposition. Typically a gaseous compound of Si, like silane (SiH₄), is introduced into a heated chamber where it decomposes by thermal energy and/or by other sources of energy (like photon energy from a light source). The Si vapor crystallizes into nanoparticles on the substrate. The Si nanocrystals embedded in silicon dioxide and the oxide is doped with erbium to obtain a green light emission for electronic application. This method only allows for emission at one wavelength so that a full range of colors cannot be achieved.

Jurbergs D., Development of Silicon Nanocrystals as High Efficiency White Phosphors, Project Portfolio: Solid State Lighting, US Department of Energy Building Technologies Program Report, pages 22-23 (November 2003) describes the use of silicon nanocrystals, made and capped in the sub-10 nm regime, to produce white light. The nanocrystals are tuned to emit various colors by adjusting the size distribution.

Yaniv, et. al., P-00: Silicon Nanocrystals Light Emission as a Novel Display Material, www.appliednanotech.net (2002), describes how to make Si nanocrystals by a supercritical solvent reaction. Diphenylsilane, a Si compound, is mixed with solvents octanol and hexane. The solution is placed in a pressure cell and heated under high pressure. Si nanocrystals of various sizes are obtained depending on the process parameters. The particles are stabilized by coating with flexible organic molecules. Similar to Jurbergs, nanocrystals are tuned to emit various colors by controlling the size distribution. The article discloses that particle diameters from 1 to 2 nm generate violet/blue luminescence, from 2.5 to 4 nm generate green/yellow, and red emission is possible with larger particles.

Amorphous Semiconductors: Doping, discloses substitution doping of amorphous semiconductors, namely, amorphous silicon and chalcogenide glasses, Encyclopedia of Materials: Science and Technology, (Elsevier Science, Ltd., 2000), http://www1.elsevier.com/homepage/sai/emsatinfo/site/Emsat_μl/site/PDFsamples/emr20 2025.pdf. The doping induces large charges in conductivity, accompanied by defect creation understood in terms of alternative bonding states of the host and impurity atoms.

Huynh, W. U. et al., CdSe Nanocrystal Rods/Poly(3-hexylthiophene) Composite Photovoltaic Devices, Advanced Materials 11(11): 923-27 (1999), discloses the construction of photovoltaic devices from a composite of 8×13 nm, elongated CdSe nanocrystals and regio-regular poly(3-hexylthiophene). This construction results in an order of magnitude increase in power conversion efficiency from previous nanocrystal/polymer heterojunction photovoltaic devices. The study found that increasing the size of the CdSe particles causes a significant increase in the energy conversion. However, the study noted that synthesis of arbitrarily large rod-like CdSe nanocrystals using the described method or solventothermal routes lead to insoluble particles that are difficult to incorporate into photovoltaic devices.

Mueller-Mach, R. et al., High-Power Phosphor-Converted Light-Emitting Diodes Based on III-Nitrides, IEEE Journal on Selected Topics in Quantum Electronics, 8(2): 339-45 (2002), discloses phosphor conversion of light emitting diode (LED) light for white light sources and monochrome applications. By loading an increasing amount of phosphor into an LED package, converts an increasing amount of blue pump light into phosphor emission and moves the blue chromaticity point to the chromaticity of the phosphor. This combination of blue pump and phosphor results in “white” emission.

U.S. Pat. No. 5,850,064 entitled “Method for photolytic liquid phase synthesis of silicon and germanium nanocrystalline materials” describes liquid phase synthesis of particles composed of silicon or germanium. The particles are made from an organometallic (tetra-organosilicon (or tetra-organogermanium) dissolved in a solvent. A light source is used to photolyze the precursors to activate the reaction, which is carried out in an inert atmosphere. A surface passivating agent is introduced to culminate the particle growth. Optionally, a dopant is incorporated during the process to modify the electronic properties of the semiconductor particle.

U.S. Pat. No. 6,268,041, entitled “Narrow Size Distribution Silicon and Germanium Nanocrystals” relates to liquid phase synthesis of particles that are composed of silicon and germanium, and are optionally made at sizes such that the particles exhibit quantum size effects. The particles are made from organometallic (tetra-organosilicon or tetra-organogermanium) precursors dissolved in a solvent that transmits a wavelength of light to photolyze the precursor. An optional dopant is incorporated to modify the electronic properties of the semiconductor particle.

Marchand, A. P., Diamondoid Hydrocarbons—Delving into Nature's Bounty, www.scienceexpress.org/28_November_{—}2002/Page_{—}1/10.1126/science.1079630, discloses hydrocarbon molecules with three-dimensional structures whose carbon-carbon framework constitutes the repeating unit in the diamond lattice. The article shows the isolation of higher diamondoids such as adamantane from crude oil, which may have important pharmaceutical applications.

Each of the above documents is incorporated herein by reference in their entireties.

The present invention provides optically enhanced nanomaterials that exhibit at least one transition in the visible spectrum. The nanomaterials of the present invention are unique in that they can be prepared from host materials that possess poor optical properties such as indirect semiconductors, by incorporating these host materials with dopants.

An example of host materials possessing poor optical characteristics is Group IV semiconductors. Group IV semiconductors are traditionally known to be unsuitable for optical applications, especially in the visible optical wavelengths due to two major reasons. First, transition from the conduction band to the valence band is indirect. At room temperature, such transitions occur from the lowest energy level of the conduction band to the highest energy level of the valance band. However, with indirect semiconductors such as Group IV, the lowest level of the conduction band and the highest level of the valance band correspond to different momentum vectors (k), so that the transitions have a simultaneous change of energy and momentum. Such simultaneous change reduces the probability of transition. Second, visible optical transitions require a band gap from about 1.8 eV (corresponding to a wavelength of about 700 nm) to about 3.1 eV (corresponding to a wavelength of about 400 nm). Group IV nanocrystals such as silicon (1.1 eV) and germanium (0.7 eV) have band gaps that are too narrow, while carbon (5.5 eV) has too wide a band gap.

There is still a need in the art to modify optical properties of materials that are poor light emitters, such as silicon, so that they can be utilized for optical applications in and around the visible.

Therefore, the present invention satisfies a need for providing optically enhanced nanomaterials obtained from the incorporation of at least one alkali metal dopant to adjust the optical spectrum of the host materials so that the resulting nanomaterial exhibits optical properties in and around the visible spectrum.

### SUMMARY OF THE INVENTION

It is an object of the present invention to produce optically enhanced nanomaterials from host materials having an optical spectrum outside of the visible spectrum by the incorporation of at least one alkali metal dopant. The nanomaterials exhibit at least one transition in the visible spectrum and may be utilized in applications such as light emitting diodes (LED) or solar cells.

The present invention relates to a nanomaterial comprising at least one host material having an optical spectrum outside of visible spectrum from about 400 nm to about 700 nm; and at least one alkali metal dopant adjusting the optical spectrum of the host material, wherein the nanomaterial exhibits at least one transition in the visible spectrum.

The host material can have an optical spectrum characterized by an energy band gap greater than about 3.1 eV.

The host material can have a maximum particle dimension of about 100 nm, and preferably, the host material can have a maximum particle dimension of about 10 nm.

The at least one alkali metal dopant can be present at a concentration from about 1 to about 20 atomic percent.

The at least one alkali metal dopant can be present at a concentration be from about 5 to about 10 atomic percent.

In another aspect, the at least one host material can comprises at least one of indirect semiconductor, insulator, or tricycloalkane.

The indirect semiconductor can comprises at least one of Group IV material or Group III-V indirect semiconductor.

The Group IV indirect semiconductor can comprise at least one of carbon (C), silicon (Si), germanium (Ge), tin (Sn), and lead (Pb).

The Group III-V indirect semiconductor can comprise at least one of boron nitride (BN), aluminum nitride (AlN), aluminum phosphide (AlP), aluminum antimonide (AlSb), or aluminum arsenide (AlAs).

The insulator can comprise at least one of polyhedral oligomeric silsesquioxane (POSS) and silicon nitride (Si₃N₄).

The tricycloalkane can comprise at least one of carbon adamantane, silicon adamantane, and germanium adamantane.

The at least one alkali metal dopant can comprise at least one of lithium, sodium, potassium, rubidium, cesium, or francium. Preferably, the alkali metal dopant comprises at least one of lithium, sodium, or potassium.

The nanomaterial can have a maximum particle dimension of about 100 nm, and preferably, the nanomaterial can have a maximum particle dimension of about 10 nm.

The present invention also relates to a nanomaterial wherein the at least one alkali metal dopant can be present at a concentration from about 5 to about 10 atomic percent; the at least one host material comprises at least one of carbon, silicon, germanium, polyhedral oligomeric silsesquioxane, silicon nitride, carbon adamantane, silicon adamantane, or germanium adamantane; and the at least one alkali metal dopant comprises at least one of lithium, sodium, or potassium.

The present invention also relates to a nanomaterial wherein the at least one alkali metal dopant can be present at a concentration from about 5 to about 10 atomic percent; wherein the at least one host material comprises at least one of carbon, silicon, germanium, polyhedral oligomeric silsesquioxane, silicon nitride, carbon adamantane, silicon adamantane, or germanium adamantane; the at least one alkali metal dopant comprises at least one of lithium, sodium, or potassium; and the nanomaterial has a maximum particle dimension of about 10 nm.

The present invention also relates to a method of preparing an optically enhanced nanomaterial comprising combining at least one host material having an optical spectrum outside of visible spectrum from about 400 nm to about 700 nm, and at least one alkali metal dopant adjusting the optical spectrum of the host material, to obtain at least one optically enhanced nanomaterial exhibiting at least one transition in the visible spectrum. Preferably, the optical spectrum of the host material can be adjusted by at least one of type of alkali metal dopant or concentration of dopant present.

The present invention also relates to a light emitting diode wherein the nanomaterial of the present invention is phosphor dispersed in a resin.

The present invention also relates to a light emitting diode comprising the nanomaterial of the present invention wherein the at least one alkali metal dopant can be present at a concentration from about 5 to about 10 atomic percent; the at least one host material comprises at least one of carbon, silicon, germanium, polyhedral oligomeric silsesquioxane, silicon nitride, carbon adamantane, silicon adamantane, or germanium adamantane; the at least one alkali metal dopant comprises at least one of lithium, sodium, or potassium; and the nanomaterial has a maximum particle dimension of about 10 nm.

The present invention also relates to a solar cell comprising the nanomaterial of the present invention.

The solar cell comprising the nanomaterial of the present invention wherein the at least one alkali metal dopant can be present at a concentration from about 5 to about 10 atomic percent; the at least one host material comprises at least one of carbon, silicon, germanium, polyhedral oligomeric silsesquioxane, silicon nitride, carbon adamantane, silicon adamantane, or germanium adamantane; the at least one alkali metal dopant comprises at least one of lithium, sodium, or potassium; and the nanomaterial has a maximum particle size of about 10 nm.

The present invention also relates to a phosphor dispersed in resin comprising the nanomaterial of the present invention.

The present invention also relates to a light absorbing layer comprising the nanomaterial of the present invention.

The present invention also relates to a solar cell comprising a light absorbing layer comprising the nanomaterial of the present invention.

The present invention also relates to a solar cell comprising the nanomaterial of the present invention wherein the at least one alkali metal dopant can be present at a concentration from about 5 to about 10 atomic percent; the at least one host material comprises at least one of carbon, silicon, germanium, polyhedral oligomeric silsesquioxane, silicon nitride, carbon adamantane, silicon adamantane, or germanium adamantane; the at least one alkali metal dopant comprises at least one of lithium, sodium, or potassium; and wherein the nanomaterial has a maximum particle dimension of about 10 nm.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 is a computer simulation of the optical spectrum of carbon adamantane.

FIG. 2 is a computer simulation of the optical spectrum of silicon adamantane.

FIG. 3 is a computer simulation of the optical spectrum of germanium adamantane.

FIG. 4 is a computer simulation of the optical spectrum of polyhedral oligomeric silsesquioxane (POSS).

FIG. 5 is a computer simulation of the optical spectrum of carbon adamantane after incorporation with lithium.

FIG. 6 is a computer simulation of the optical spectrum of carbon adamantane after incorporation with sodium.

FIG. 7 is a computer simulation of the optical spectrum of carbon adamantane after incorporation with potassium.

FIG. 8 is a computer simulation of the optical spectrum of carbon adamantane after incorporation with rubidium.

FIG. 9 is the optical spectrum of silicon adamantane after incorporation with lithium.

FIG. 10 is a computer simulation of the optical spectrum of silicon adamantane after incorporation with sodium.

FIG. 11 is a computer simulation of the optical spectrum of silicon adamantane after incorporation with potassium.

FIG. 12 is a computer simulation of a computer simulation of the optical spectrum of silicon adamantane after incorporation with rubidium.

FIG. 13 is a computer simulation of a computer simulation of the optical spectrum of germanium adamantane after incorporation with lithium.

FIG. 14 is a computer simulation of the optical spectrum of germanium adamantane after incorporation with sodium.

FIG. 15 is a computer simulation of the optical spectrum of germanium adamantane after incorporation with potassium.

FIG. 16 is a computer simulation of the optical spectrum of germanium adamantane after incorporation with rubidium.

FIG. 17 is a computer simulation of the optical spectrum of POSS after incorporation with lithium.

FIG. 18 is a computer simulation of the optical spectrum of POSS after incorporation with sodium.

FIG. 19 is a computer simulation of the optical spectrum of POSS after incorporation with potassium.

FIG. 20 is a computer simulation of a computer simulation of the optical spectrum of POSS after incorporation with rubidium.

FIG. 21 is a computer simulation of a structure of adamantane showing its stability at nm dimensions.

FIG. 22 is a computer simulation of a diamond nanocrystal from which adamantane may be carved out. Adamantane is the smallest stable cage that can be obtained from a diamond type crystal with a dimension of about 0.5 nm along the diagonal. Since carbon, silicon and germanium have a diamond crystal structure, adamantane is chosen as the computer model.

FIG. 23 is a schematic of energy levels of nanomaterial. Emission 1 is defined as the transition from excited state 0 to ground state 0. Emission 2 is defined as the transition from excited state 1 to ground state 0. Absorption is defined as the transition from ground state 0 to excited state 3.

FIG. 24 shows calculations for different concentrations of sodium incorporated into germanium nano host. The wavelength (nm) makes up the y-axis, and the number of sodium atoms makes up the x-axis. The wavelengths of the defined optical transitions increase with increasing concentration of sodium. The most increase is observed with 1 to 2 sodium atoms per germanium nano host. The number of alkali atoms incorporated into the nano host may be used as a parameter to tune the wavelength of optical transitions.

FIG. 25 shows the structure of a typical light emitting diode (LED) used in illumination. A LED of blue or violet color output is used as an optical pump. Photons emitted by the pump are absorbed by phosphor particles placed in the output path. Phosphor particles have characteristic emission wavelength that is different and longer than the pump LED.

FIG. 26 shows the simplified structure of a solar cell. The light absorbing layer containing particles are formed on a substrate that contains the bottom electrode. The transparent top electrode is formed on top of the absorbing layer. When solar light is absorbed, electrons and holes are generated that drift to opposite electrodes and generate current.

FIG. 27 shows a computer generated model of carbon adamantane.

FIG. 28 is a computer generated cubic, cage type molecule of POSS made up of silicon, oxygen, and hydrogen (Si₈O₁₂H₈).

FIG. 29 is a computer atomic model showing an example of two potassium atoms incorporated into a germanium nano host.

FIG. 30 is a computer atomic model showing an example of two potassium atoms incorporated into POSS nano host.

### DETAILED DESCRIPTION OF THE PRESENT INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

An objective of the present invention is to modify optical properties of host materials that are poor light emitters (e.g., silicon (Si)) so that these materials may be useful for optical applications in and around the visible spectrum.

The present invention relates to optically enhanced nanomaterials comprising at least one host material having an energy gap such that its optical spectrum is outside of the visible spectrum (from about 400 nm to about 700 nm), and at least one dopant, so that the optically enhanced nanomaterials exhibit at least one transition in the visible spectrum. The present invention also relates to methods of preparing optically enhanced nanomaterials, methods of using the optically enhanced nanomaterials, methods of producing optically enhanced nanomaterials, and products including the optically enhanced nanomaterials such as light emitting diodes and solar cells.

“Nano” of the present invention refers to materials or host materials having a maximum dimension of about 100 nm, and most preferably a maximum dimension of about 10 nm.

The present invention provides optically enhanced nanomaterials that possess at least one transition in the visible spectrum. Without wishing to be bound by theory, the nanomaterials of the present invention are unique in that they are optically enhanced from host materials that are poor semiconductors by incorporating alkali metal dopants to modify the energy levels of the host material creating optical transitions at wavelengths of interest in the visible spectrum.

The present invention provides a method of enhancing the optical spectrum of host materials that exhibit optical properties outside of the visible spectrum by doping them with alkali metal dopants. Preferably, the present invention provides a method of enhancing the optical properties of host materials that are inefficient semiconductors so that these host materials are converted to nanomaterials that are beneficial and efficient semiconductors, useful for commercial application. Specifically, the nanomaterials of the present invention may be used in applications such as light emitting diodes or solar cells, where light emission or absorption in the visible range is required. Thus, the present invention provides a method of using the optically enhanced nanomaterial in applications including optoelectronic systems (e.g., light emitting diodes), photovoltaic cells (e.g., solar cells), and as components of nanoelectronic devices.

Host materials according to the present invention can comprise various materials that exhibit optical properties outside of the visible spectrum, such as indirect semiconductors with optical properties inferior to Group III-Group V direct semiconductor compounds like gallium arsenide (GaAs), and Group II-Group VI direct semiconductor compounds like cadmium selenide (CdSe). Such indirect semiconductors can have band gaps that are too narrow or too wide for optical applications in the visible. These indirect semiconductors can possess: (1) an energy difference between the lowest excited state and the highest ground state that is not in the range of photon energies corresponding to visible wavelengths; and (2) an optical transition from the lowest excited state to the highest ground state with a low transition probability (small oscillator strength) as compared to transitions from higher excited states to the ground state (high oscillator strength).

Without wishing to be bound by theory, the host material of the present invention may possess a small oscillator strength that corresponds to the longest wavelength, radiative optical transitions are less likely to occur. In general, radiative optical transitions are more likely to occur from lowest excited state to the ground state rather than from the highest excited states to the ground state. For example, silicon or germanium does not have maximum oscillator strength that corresponds to the longest wavelength.

The host material that may be used in the present invention may be modified by a method of gap broadening to widen the energy band gaps of host materials possessing narrow energy band gaps. The gap broadening process may be accomplished in any manner to reduce the size of the host material such as down to nanometer dimensions. When the energy difference between the lowest excited state and highest ground state of the host material in its bulk form is too small to accommodate visible wavelengths, the energy gap may be broadened before dopants are introduced. This process of gap broadening facilitates incorporation of dopants by reducing the size of the host material down to nanometer dimensions. The dopants are then incorporated into the host material following gap broadening. Therefore, it is a desirable feature of the present invention to use host materials with energy band gaps wide enough to accommodate visible wavelengths; or to modify the host materials to obtain stable nanostructures with band gaps wide enough to accommodate visible wavelengths.

The host material contemplated for optical modification in accordance with the present invention has an optical spectrum outside of the visible spectrum, meaning that the host material may possess an optical spectrum less than about 400 nm or greater than about 700 nm, with no optical transitions in the visible spectrum. The visible spectrum is from about 400 nm (corresponding to about 3.1 eV) to about 700 nm (corresponding to about 1.8 eV). Preferably, the host material has an optical spectrum in the ultraviolet (UV) spectrum that is about 200 nm to about 400 nm. The host material of the present invention has an optical spectrum that may be characterized as having an energy band gap greater than about 3.1 eV.

The host material of the present invention preferably has a maximum particle dimension of about 100 nm, and most preferably, a maximum particle dimension of about 10 nm.

Host materials that may be used in the present invention preferably include, but are not limited to, indirect semiconductor (eg., Group IV or Group III-V indirect semiconductor), insulator, tricycloalkane, and combinations thereof.

The Group IV indirect semiconductor includes carbon (C), silicon (Si), germanium (Ge), tin (Sn), lead (Pb), and combinations thereof. The Group III-V indirect semiconductor includes, but is not limited to, boron nitride (BN), aluminum nitride (AlN), aluminum phosphide (AlP), aluminum antimonide (AlSb), aluminum arsenide (AlAs), and combinations thereof.

The insulator includes, but is not limited to, polyhedral oligomeric silsesquioxane, silicon nitride, and combinations thereof.

The tricycloalkane includes, but is not limited to, carbon adamantane, silicon adamantane, germanium adamantane, and combinations thereof.

The host materials may also be combined in any manner. For example, combinations of Group IV materials that may also be used in the present invention include, but are not limited to, silicon carbide and silicon germanium alloys.

More preferably, the host materials include, but are not limited to, carbon, silicon, germanium, tin, lead, silicon carbide, silicon, germanium, polyhedral oligomeric silsesquioxane, silicon nitride, carbon adamantane, silicon adamantane, germanium adamantane, and combinations thereof. Most preferably, the host materials include, but are not limited to, carbon, silicon, germanium, polyhedral oligomeric silsesquioxane, silicon nitride, carbon adamantane, silicon adamantane, germanium adamantane, and combinations thereof.

Alkali metal dopants that may be used in the present invention include lithium, sodium, potassium, rubidium, cesium, francium, and mixtures thereof. More preferably, the alkali metal dopants include lithium, sodium, potassium, cesium, and mixtures thereof. Most preferably, the alkali metal dopants include lithium, sodium, potassium, and mixtures thereof.

The type of alkali metal dopant and/or concentration of alkali metal dopant may be used as parameters to tune the modification of the host material. This is an important feature of the present invention that the type of dopant and/or concentration of dopant may be used as a parameter to tune the wavelength of optical transitions exhibited by a host material. The present invention allows one of skill in the art to tailor the spectrum of the resulting nanomaterial by proper selection of the host material as well as the dopant. For example, as shown in FIG. 24, the wavelengths of the defined optical transitions by a germanium host material increases with increasing concentrations of sodium as the dopant.

The dopant may be present preferably at a concentration of about 1 to about 20 atomic percent. Most preferably, the concentration of dopant present is from about 5 to about 10 atomic percent. The dopant may be incorporated by distributing the dopant on the surface of the material, or throughout the body of the material.

Optical properties of nanomaterials comprising materials such as Group IV materials (e.g., carbon, silicon, germanium) and insulators (e.g., polyhedral oligomeric silsesquioxane), incorporated with alkali metal dopants (e.g., sodium or potassium) may be investigated by using quantum mechanical simulations. For example, host materials with a size less than 1 nm have wide band gaps significantly greater than 3 eV, hence they do not exhibit any optical transitions in the visible range. Incorporation of alkali atoms as dopants dramatically alters the energy levels of these host materials, giving rise to optical transitions in and around the visible. This alteration makes these materials suitable for applications like light emitting diodes or solar cells where light emission or absorption in that range is necessary.

The nanomaterial of the present invention has a maximum particle dimension of about 100 nm, and most preferably a maximum particle dimension of about 10 nm.

The nanomaterials of the present invention can be prepared by any method. For instance, such methods include incorporating at least one dopant into at least one host material having an optical spectrum outside of the visible spectrum; wherein the visible spectrum is from about 400 nm to about 700 nm; and the optically enhanced nanomaterial exhibits at least one transition in the visible spectrum; and wherein the optical spectrum of the nanomaterial may be adjusted by the alkali metal dopant and/or concentration of alkali metal dopant present.

The dopants of the present invention may be incorporated into the host materials by any method. For example, alkali atoms can be incorporated into the host material by replacing two hydrogen atoms at the surface of the host material. As noted above, the type and concentration of alkali atoms will determine the optical spectrum of the nanomaterial. For example, carbon adamantane may be reacted with two sodium atoms to form sodium carbon adamantane. Other examples of methods that may be used to incorporate dopants of the present invention include, but are not limited to:
(1) Chemical vapor deposition as described in Brown, C., ST Lights up Silicon LED for CMOS Fab Lines, Electronic Engineering Times, www.eetimes.com/story/OEG20021029S0027 (Nov. 4, 2002).
(2) Supercritical solvent reaction as described in Yaniv, et. al., P-00: Silicon Nanocrystals Light Emission as a Novel Display Material, SID 00 Digest: 1-2.
(3) Liquid phase synthesis as described in U.S. Pat. Nos. 6,268,041 and 5,850,064.
(4) Solid-gas reaction as described in Acker et al., Synthesis of Silicon Nanoclusters by Solid-Gas Reaction, Advanced Materials 12(21): 1605 (Nov. 2, 2000).
(5) Diffusion into the host from an alkali solid in contact with the host as described in Shim et al., N-type Colloidal Semiconductor Nanocrystals, Nature 407: 981 (Oct. 26, 2000).
(6) Vacuum evaporation from a heated alkali source as described in Bockrath et al., Chemical Doping of Individual Semiconducting Carbon Nanotube Ropes, Physical Review 61: 10606-10608 (2000).
(7) Ion implantation of ionized alkali atoms as described in Street, Amorphous Semiconductors: Doping, Encyclopedia of Materials: Science and Technology, (Elsevier Science Ltd., 2000).
(8) Reaction in an electrochemical cell where one of the electrodes is an alkali metal, as described in Shim, et al., Lithium Intercalation into Opened Single Wall Carbon Nanotubes: Storage Capacity and Electronic Properties, Physical Review Letters, Vol. 88(1): 015502 (Jan. 7, 2002).
   Each of these documents is incorporated herein by reference in their entireties.

For purposes of the present invention, the optical properties of the host material without any dopants may be calculated. Preferably, optical properties of the host material without any dopants, and nanomaterials, may be calculated with computer software such as Hyperchem (Hypercube; Gainesville, Fla.) software for quantum mechanical calculations, and the dopants incorporated by computer simulation. Several values of the wavelength and the oscillator strength are used to provide a reference for the scale. As discussed above, the spectrum of the host materials show that: (1) all the optical transitions are in the UV spectrum with no optical transitions in the visible spectrum (from about 400 nm to about 700 μm); and (2) the maximum oscillator strength does not correspond to the longest wavelength. Next, the optical spectrum of the materials incorporated with dopants (e.g., alkali atoms) may be calculated. Without wishing to be bound by theory, the optical spectrum may show:
1) Significant change in the spectrum of the host material with optical transitions in and around the visible spectrum.
2) Each dopant atom (e.g., alkali) contributes multiple optical transitions, creating the possibility of multiple wavelength emissions and absorptions in and around the visible. Such a feature is highly advantageous for the intended applications of the present invention (e.g., light emitting diodes and solar cell).
3) Maximum oscillator strength corresponding to the longest wavelength in the spectrum. This result means that radiative optical transitions are more likely to happen from the lowest excited state to the ground state. Addition of the dopant atoms (e.g., alkali atoms) alters the indirect nature of the nano host material, creating an opportunity to use the combined material as an efficient light emitter.
4) The optical transitions shift to longer wavelengths corresponding to the atomic weight of the dopant atom (e.g., alkali) so that as the dopant gets heavier, the optical transitions shift to longer wavelengths. The optical transitions in and around the visible spectrum may be tailored by proper selection of the host material and the type of dopant to be incorporated.

The nanomaterials of the present invention may be used in applications where optical transitions in and around the visible are desirable. Two examples of such applications are phosphor for light emitting diodes (LEDs) and particulate material for the absorbing layer of solar cells.

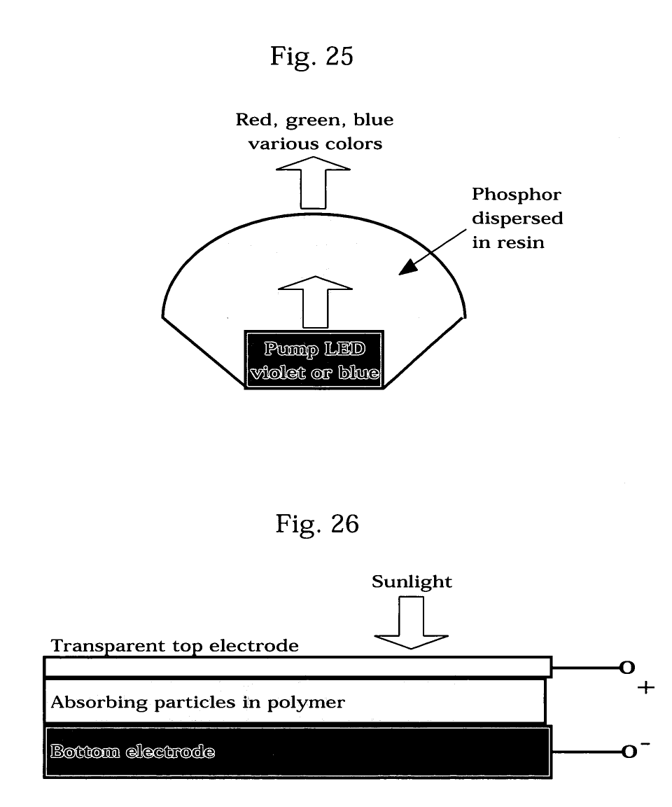

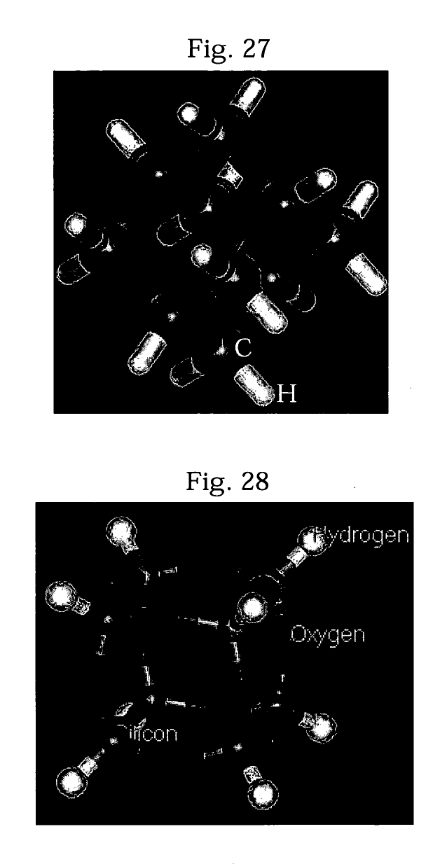

In one application, the nanomaterial of the present invention may be used as phosphor for LED application. As shown in FIG. 25, photons emitted by the pump are absorbed by phosphor particles placed in the output path. Phosphor particles have characteristic emission wavelength which is different and longer than the pump LED. For example, for white light illumination the pump can be of blue color and phosphor particles can be chosen to emit green and red colors. When three colors are emitted simultaneously, the mixed output of the LED looks white.

The nanomaterial of the present invention is especially advantageous for phosphor application, because:
a) Multiple emission lines in the visible can be obtained by each combination of host and alkali atom.
b) The spectral lines can be adjusted by proper selection of host material and alkali atom, since many selections are possible.
c) Furthermore, the spectral lines can be adjusted by proper choice of the density of the alkali atoms incorporated to the host.

In a preferred embodiment, the nanomaterial of the present invention wherein the average concentration of dopant present is from about 5 to about 10 atomic percent; the host material comprises at least one of carbon, silicon, germanium, polyhedral oligomeric silsesquioxane, silicon nitride, carbon adamantane, silicon adamantane, or germanium adamantane; the dopant comprises at least one of lithium, sodium, or potassium; and the nanomaterial has an average maximum particle dimension of about 10 nm.

In a preferred embodiment, the present invention is used in a light emitting diode as phosphor dispersed in a resin wherein the average concentration of dopant present is from about 5 to about 10 atomic percent; the host material comprises at least one of carbon, silicon, germanium, polyhedral oligomeric silsesquioxane, silicon nitride, carbon adamantane, silicon adamantane, or germanium adamantane; the dopant comprises at least one of lithium, sodium, or potassium; and the nanomaterial has a maximum particle dimension of about 10 nm.

In another application, the nanomaterial of the present invention may be used for solar cells. Solar cells are typically made of crystalline silicon by using semiconductor processing operations. However there is a need for low cost processing to bring the cost of solar generated electricity down. One approach is to mix light absorbing particles of semiconductors with a suitable polymer and to coat the mixture onto a substrate. This method allows large area solar cells to be produced at relatively low cost. The simplified structure of such a solar cell is shown in FIG. 26. The light absorbing layer containing the particles are formed on a substrate which contains the bottom electrode. Transparent top electrode is formed on top of the absorbing layer. When solar light is absorbed, electrons and holes are generated which drift to opposite electrodes and generate current. Solar light has a rather broad spectrum from near UV to near IR. It is desirable to absorb the light at several different wavelengths to increase efficiency. Currently several different semiconductors are used in tandem to achieve this purpose. Similar to the LED application, multiple spectral lines of the nanomaterial of the present invention may be used to absorb light over the solar spectrum. The absorption spectrum can be adjusted by proper selection of the host material, the dopant and the density of the dopant.

The nanomaterials of the present invention may be used in a solar cell comprising a light absorbing layer wherein the absorbing layer comprises at least one host material having an optical spectrum outside of the visible spectrum; and at least one alkali metal dopant; wherein the visible spectrum is from about 400 nm to about 700 nm, and wherein the nanomaterial exhibits at least one transition in the visible spectrum.

In a preferred embodiment, the nanomaterials of the present invention may be used in a solar cell wherein the average concentration of dopant present is from about 5 to about 10 atomic percent; the host material comprises at least one of carbon, silicon, germanium, polyhedral oligomeric silsesquioxane, silicon nitride, carbon adamantane, silicon adamantane, or germanium adamantane; the dopant comprises at least one of lithium, sodium, or potassium; and the nanomaterial has an average maximum particle dimension of about 10 nm.

### EXAMPLES

The invention is illustrated in the following non-limiting examples, which are provided for the purpose of representation, and are not to be construed as limiting the scope of the invention.

### Example 1

### Calculation of Optical Properties

The optical properties of the host material without any dopants, and nanomaterials according to the present invention, may be calculated using Hyperchem (from Hypercube; Gainesville, Fla.) software for quantum mechanical calculations. The software implements first principal quantum mechanical calculation methods like Ab Initio or Density Functional Theory (DFT) and semi-empirical methods like Austin Method 1 (AM1). Nanocrystal constructs are created with Hyperchem's graphical user interface (which builds models atom by atom) by the following steps:
(a) Determining the properties of the crystal unit cell including the crystal structure, dimensions of the unit cell, atoms in the unit cell, and coordinates of atoms in the unit cell. For example, all Group IV crystals possess a diamond-like crystal structure where the unit cell is a cube containing 8 atoms of the element. The size of the cube for carbon is 0.356 nm, silicon is 0.543 nm, and germanium is 0.565 nm.
(b) Determining the amount of unit cells required to be stacked in each direction to make the nanocrystal. For example, stacking 2 unit cells of silicon in each direction would yield a nanocrystal having dimensions of approximately 1 nm (2×0.543 nm). Such a nanocrystal would consist of 8 unit cells and contain 64 silicon atoms (8×8=64).
(c) Pruning the nanocrystal to obtain a stable structure. Stable nanostructures maintaining the original crystalline arrangement are desirable for experimental implementation. An example of such a structure encountered in nature is a cage-like molecule known as adamantane, which is the smallest stable cage that may be constructed from a diamond type crystal with a dimension of approximately 0.5 nm along the diagonal. For purposes of this invention, adamantane will be used as the model for carbon, silicon, and germanium.
(d) Treating the surface of the computer model to remove incomplete bonds. The surface of the model is passivated by attaching hydrogen molecules to incomplete bonds.

### Example 2

### Quantum Mechanical Calculations Using Ab Initio

Quantum mechanical calculations of Example 1 may be done using Ab Initio, which performs a Self Consistent Field (SCF) Hartree-Fock calculation with a chosen basis set to obtain a set of occupied orbitals (ground state) and unoccupied orbitals (excited states). A Configuration Interaction (CI) calculation is then done with a chosen subset of the orbitals to refine the calculation, especially for excited states. The CI calculation allows Hyperchem to determine the UV and visible spectra automatically for the host material, providing wavelength and oscillator strength of each transition in the spectrum. The basis set provides a mathematical description of the wavefunction. Usually, three basis sets are chosen depending on the elements included in the model and in accordance with the restrictions of the Hyperchem software: (1) 6-31G* is chosen for elements from hydrogen to zinc, and is used for calculations involving carbon, silicon, oxygen, hydrogen, lithium, sodium, and potassium; (2) 6-311G* is chosen for elements from hydrogen to krypton, and is used for calculations involving germanium, hydrogen, lithium, sodium, and potassium; and (3) 3-21G* is chosen for elements from hydrogen to xenon, and is used for calculations involving rubidium. Convergence criteria for the SCF calculations is set to 10⁻⁵ kcal/mol. The CI is performed with 9 occupied and 9 unoccupied orbitals. More accurate results are usually obtained with increasing number of orbitals in CI, with 9 orbitals being the maximum.

### Example 3

### Quantum Mechanical Calculations Using DFT

Quantum mechanical calculations of Example 1 were done using DFT, which performs a DFT calculation to obtain a set of occupied and unoccupied energy levels. Then the energy difference between unoccupied and occupied levels is used to calculate the wavelength of optical transitions. DFT calculations are performed using popular hybrid functional B3-LYP. The grid chosen for the integration is Pople's Standard Grid #1. Similar to Ab Initio calculations discussed above, basis sets and convergence criteria are the same.

### Example 4

### Verification of Quantum Mechanical Calculations

The DFT calculations in Example 3 may be performed to verify the results obtained by Ab Initio in Example 2 by means of a second independent calculation method. Table 1 shows a comparison of the longest optical transition wavelength obtained by Ab Initio and DFT for each nanomaterial. Wavelengths calculated by DFT are longer on the average by about 20%. This difference is due to the way electron-electron interactions are handled in the calculation algorithm.

TABLE 1

| | | Ab initio | DFT | |
|---|---|---|---|---|
| Nano | Alkali | wavelength | wavelength | Difference |
| host | element | (nm) | (nm) | % |
| C | Li | 655 | 850 | 23 |
| | Na | 703 | 855 | 18 |
| | K | 1181 | 1292 | 9 |
| Si | Li | 411 | 468 | 12 |
| | Na | 468 | 552 | 15 |
| | K | 596 | 754 | 21 |
| Ge | Li | 444 | 511 | 13 |
| | Na | 480 | 580 | 17 |
| | K | 605 | 775 | 22 |
| POSS | Li | 339 | 363 | 7 |
| | Na | 350 | 414 | 16 |
| | K | 443 | 544 | 19 |

### Example 5

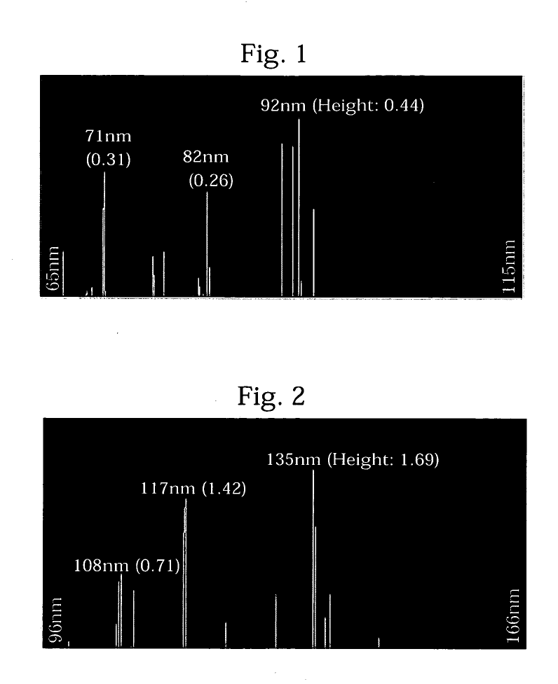

Computer simulation of the optical properties of carbon adamantane host material is determined according to Example 1, and the spectrum provided in FIG. 1. The horizontal axis is wavelength in nanometer (nm), and the vertical axis is oscillator strength (transition probability). The spectrum shows that the carbon adamantane host material is in the UV spectrum with no transitions in the visible spectrum (about 400 nm to about 700 nm). Also, the maximum oscillator strength does not correspond to the longest wavelength.

### Example 6

Computer simulation of the optical properties of silicon adamantane host material are determined according to Example 1, and the spectrum provided in FIG. 2. The horizontal axis is wavelength in nanometer (nm), and the vertical axis is oscillator strength (transition probability). The spectrum shows that the silicon adamantane host material is in the UV spectrum with no transitions in the visible spectrum (about 400 nm to about 700 nm). This result shows that even when silicon which has a narrow band gap, undergoes band gap broadening, the longest optical transition still occurs deep in the UV spectrum. Also, the maximum oscillator strength does not correspond to the longest wavelength.

### Example 7

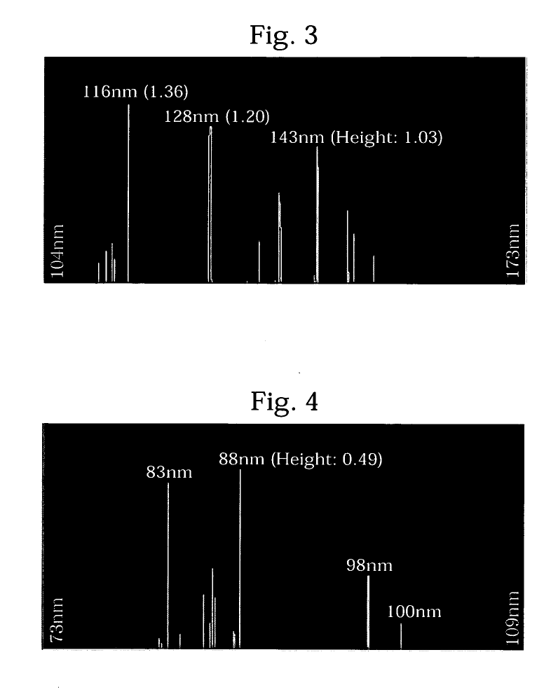

Computer simulation of the optical properties of germanium adamantane host material is determined according to Example 1, and the spectrum provided in FIG. 3. The horizontal axis is wavelength in nanometer (nm), and the vertical axis is oscillator strength (transition probability). The spectrum shows that the germanium adamantane host material is in the UV spectrum with no transitions in the visible spectrum (about 400 nm to about 700 nm). This result shows that even when germanium which has a narrow band gap, undergoes band gap broadening, the longest optical transition still occurs deep in the UV spectrum. Also, the maximum oscillator strength does not correspond to the longest wavelength.

### Example 8

Computer simulation of the optical properties of POSS nano host material are determined according to Example 1, and the spectrum provided in FIG. 4. The horizontal axis is wavelength in nanometer (nm), and the vertical axis is oscillator strength (transition probability). The spectrum shows that the POSS host material is in the UV spectrum with no transitions in the visible spectrum (about 400 nm to about 700 nm). Also, the maximum oscillator strength does not correspond to the longest wavelength.

### Example 9

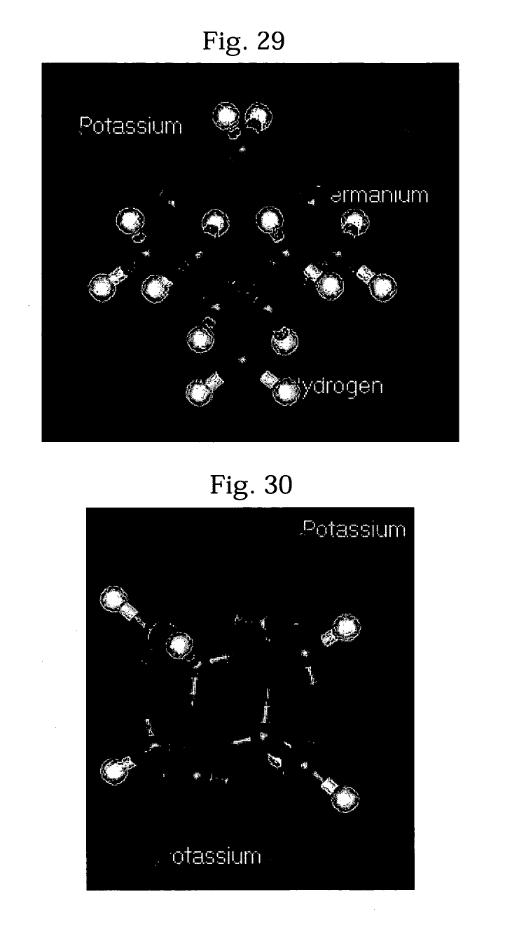

Computer simulation of the optical properties of carbon adamantane with alkali metal dopants is determined according to Example 1. The alkali atoms are introduced by replacing two hydrogen atoms on the surface of the nano host atoms as shown in FIG. 29 or FIG. 30. Incorporation of the following alkali dopants are done via computer simulation.

A. Incorporation of carbon adamantane host with lithium dopant provides nanomaterial with the spectrum in FIG. 5 with two transitions in the visible spectrum at 540 nm and 655 nm.

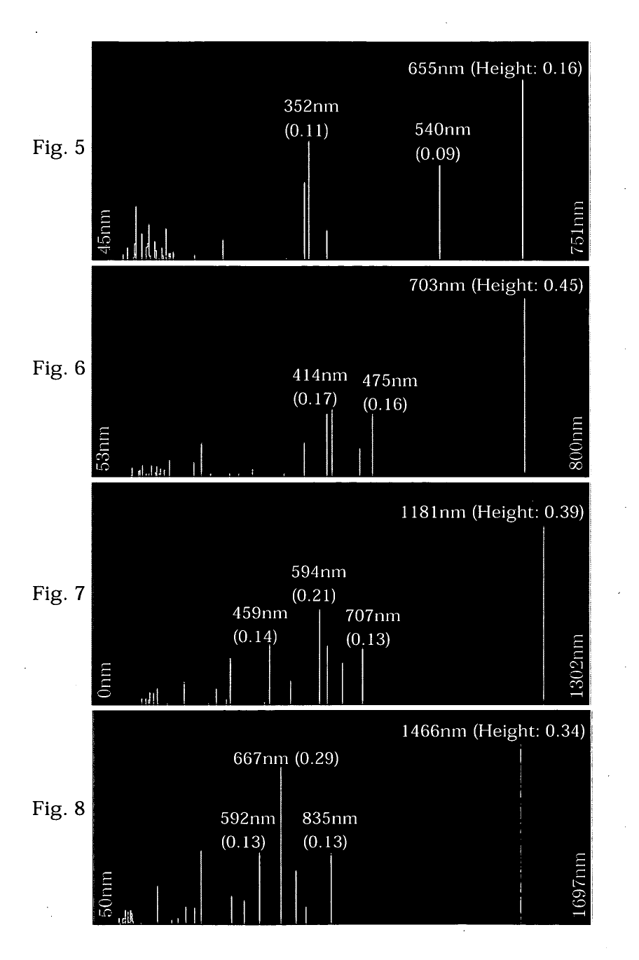

B. Incorporation of carbon adamantane host with sodium dopant provides nanomaterial with the spectrum in FIG. 6 with three transitions in the visible spectrum at 414 nm, 475 nm, and 703 nm.

C. Incorporation of carbon adamantane host with potassium dopant provides nanomaterial with the spectrum in FIG. 7 with three transitions in the visible spectrum at 459 nm, 594 nm, and 707 nm.

D. Incorporation of carbon adamantane host with rubidium dopant provides nanomaterial with the spectrum in FIG. 8 with two transitions in the visible spectrum at 592 nm and 667 nm.

The alkali metal atoms cause: (1) a significant change in the spectrum of the carbon adamantane such that optical transitions in and around the visible spectrum are obtained; (2) multiple optical transitions creating the possibility of multiple wavelength emissions and absorptions in and around the visible spectrum; (3) an alteration in the indirect nature of the carbon adamantane by making it more likely for radiative optical transitions to occur from the lowest excited state to the ground state (this creates an opportunity to use the combined material as an efficient light emitter); and (4) optical transitions to shift to longer wavelengths as the alkali atom gets heavier. The optical transitions in and around the visible spectrum may be tailored by the particular nano host material and type of alkali atom chosen.

### Example 10

Computer simulation of the optical properties of silicon adamantane with alkali metal dopants is determined according to Example 1. The alkali atoms are introduced by replacing two hydrogen atoms on the surface of the nano host atoms as shown in FIG. 29 or FIG. 30. Incorporation of the following alkali dopants are done via computer simulation.

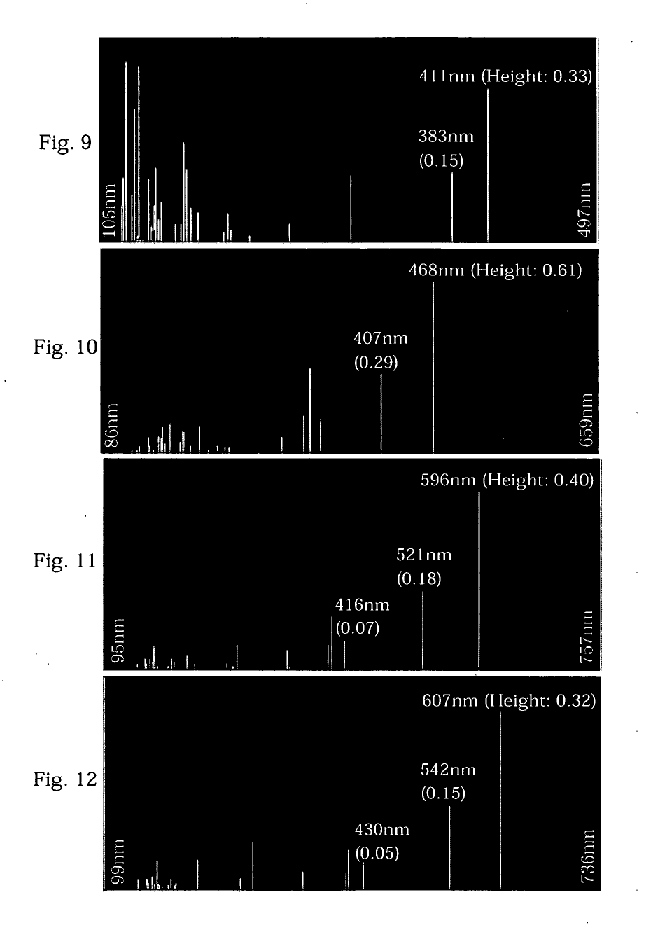

A. Incorporation of silicon adamantane host with lithium dopant provides nanomaterial with the spectrum in FIG. 9 with two transitions in the visible spectrum at 383 nm and 411 nm.

B. Incorporation of silicon adamantane host with sodium dopant provides nanomaterial with the spectrum in FIG. 10 with two transitions in the visible spectrum at 407 nm and 468 nm.

C. Incorporation of silicon adamantane host with potassium dopant provides nanomaterial with the spectrum in FIG. 11 with three transitions in the visible spectrum at 416 nm, 521 nm, and 596 nm.

D. Incorporation of silicon adamantane host with rubidium dopant provides nanomaterial with the spectrum in FIG. 12 with three transitions in the visible spectrum at 430 nm, 542, and 607 nm.

The alkali metal atoms cause: (1) a significant change in the spectrum of the silicon adamantane such that optical transitions in and around the visible spectrum are obtained; (2) multiple optical transitions creating the possibility of multiple wavelength emissions and absorptions in and around the visible spectrum; (3) an alteration in the indirect nature of the silicon adamantane by making it more likely for radiative optical transitions to occur from the lowest excited state to the ground state (this creates an opportunity to use the combined material as an efficient light emitter); and (4) optical transitions to shift to longer wavelengths as the alkali atom gets heavier. The optical transitions in and around the visible spectrum may be tailored by the particular nano host material and type of alkali atom chosen.

### Example 11

Computer simulation of the optical properties of germanium adamantane with alkali metal dopants is determined according to Example 1. The alkali atoms are introduced by replacing two hydrogen atoms on the surface of the nano host atoms as shown in FIG. 29 or FIG. 30. Incorporation of the following alkali dopants are done via computer simulation.

A. Incorporation of germanium adamantane host with lithium dopant provides nanomaterial with the spectrum in FIG. 13 with two transitions in the visible spectrum at 415 nm and 444 nm.

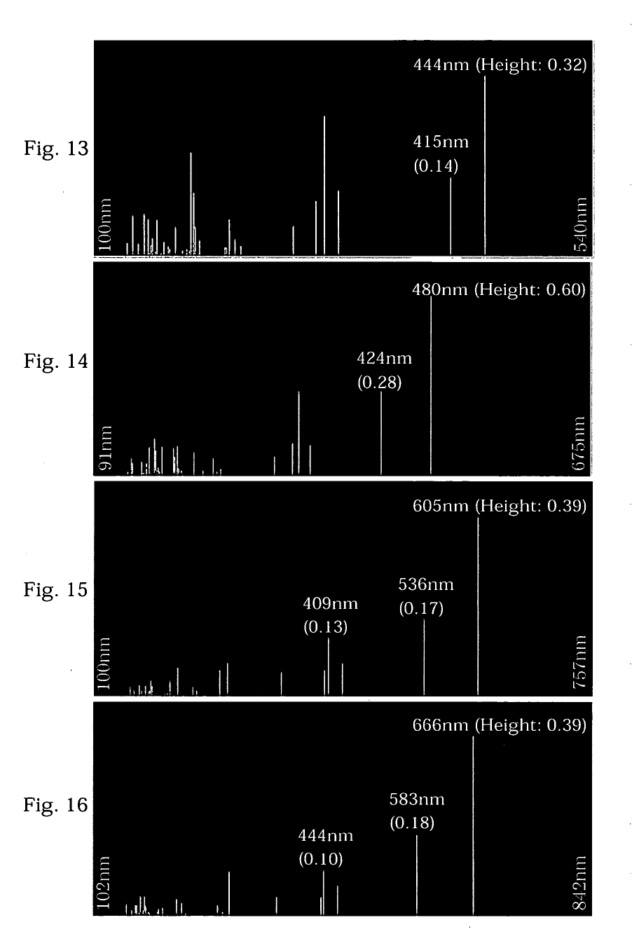

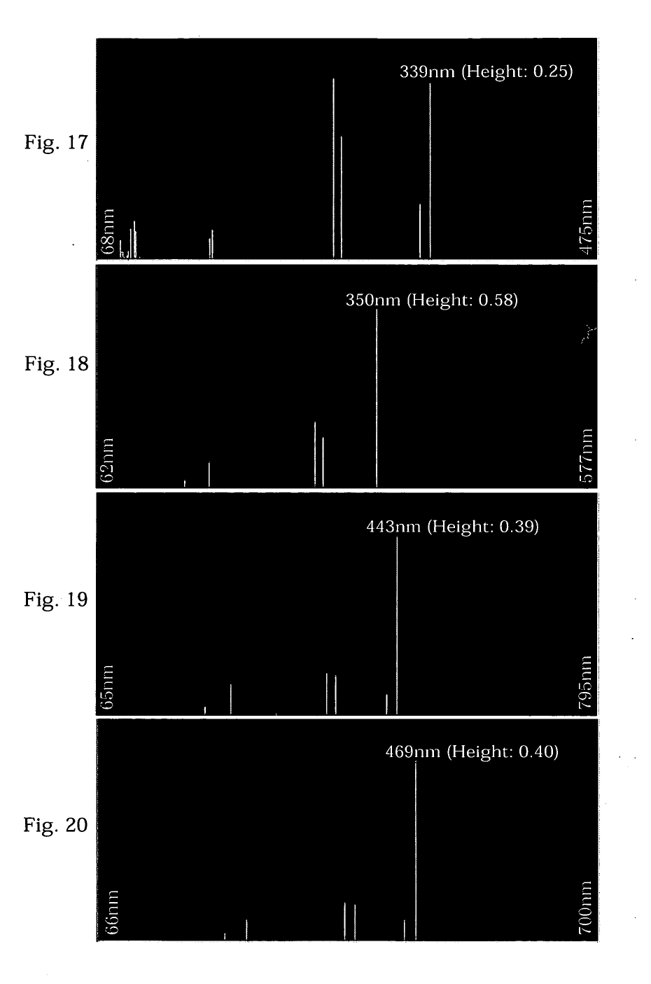

B. Incorporation of germanium adamantane host with sodium dopant provides nanomaterial with the spectrum in FIG. 14 with two transitions in the visible spectrum at 424 nm and 480 nm.

C. Incorporation of germanium adamantane host with potassium dopant provides nanomaterial with the spectrum in FIG. 15 with three transitions in the visible spectrum at 409 μm, 536 nm, and 605 nm. The spectrum shows lines in the blue (409 nm), green (536 nm), and orange (605 nm) colors. The material can absorb blue and emit green and orange colors. This feature alleviates the need for multiple phosphors consisting of different materials.

D. Incorporation of germanium adamantane host with rubidium dopant provides nanomaterial with the spectrum in FIG. 16 with three transitions in the visible spectrum at 444 nm, 583 nm, and 666 nm.

The alkali metal atoms cause: (1) a significant change in the spectrum of the germanium adamantane such that optical transitions in and around the visible spectrum are obtained; (2) multiple optical transitions creating the possibility of multiple wavelength emissions and absorptions in and around the visible spectrum; (3) an alteration in the indirect nature of the germanium adamantane by making it more likely for radiative optical transitions to occur from the lowest excited state to the ground state (this creates an opportunity to use the combined material as an efficient light emitter); and (4) optical transitions to shift to longer wavelengths as the alkali atom gets heavier. The optical transitions in and around the visible spectrum may be tailored by the particular nano host material and type of alkali atom chosen.

### Example 12

Computer simulation of the optical properties of POSS nano host with alkali metal dopants is determined according to Example 1. The alkali atoms are introduced by replacing two hydrogen atoms on the surface of the nano host atoms as shown in FIG. 29 or FIG. 30. Incorporation of the following alkali metal dopants is done via computer simulation.

A. Incorporation of POSS nano host with lithium dopant provides nanomaterial with an optical spectrum having one transition close to the visible spectrum at 339 nm (FIG. 17).

B. Incorporation of POSS nano host with sodium dopant provides a nanomaterial having a spectrum with one transition close to the visible spectrum at 350 nm. This example shows that increasing the concentration of sodium dopant will shift the transition to the right into the visible spectrum.

C. Incorporation of POSS nano host with potassium dopant provides nanomaterial with the spectrum in FIG. 19 with one transition in the visible spectrum at 443 nm.

D. Incorporation of POSS nano host with rubidium dopant provides nanomaterial with the spectrum in FIG. 20 with one transition in the visible spectrum at 469 nm.

The alkali metal atoms cause: (1) a significant change in the spectrum of the POSS such that optical transitions in and around the visible spectrum are obtained; (2) multiple optical transitions creating the possibility of multiple wavelength emissions and absorptions in and around the visible spectrum; (3) an alteration in the indirect nature of the POSS by making it more likely for radiative optical transitions to occur from the lowest excited state to the ground state (this creates an opportunity to use the combined material as an efficient light emitter); and (4) optical transitions to shift to longer wavelengths as the alkali atom gets heavier. The optical transitions in and around the visible spectrum may be tailored by the particular nano host material and type of alkali atom chosen.

### Example 13

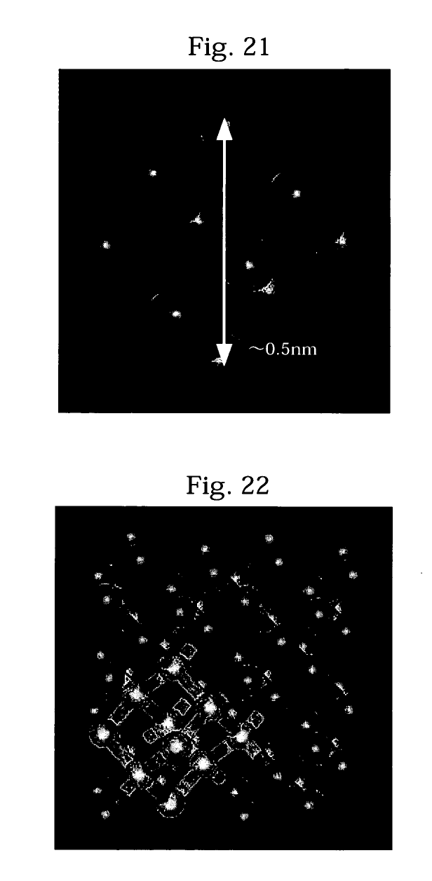

Nanocrystal construct of carbon adamantane created with the graphical user interface using the Hyperchem software according to Example 1 provides the atom by atom model of adamantane in FIG. 21. The nanocrystal structure of carbon adamantane is stable because of its similarity to the diamond nanocrystal structure in FIG. 22.

### Example 14

Results of calculations for various concentrations of sodium incorporated into germanium nano host materials are graphed in FIG. 24. The graph shows that the wavelengths of the defined optical transitions increase with increasing concentration of sodium. The increase is most notable from 1 to 2 sodium atoms per germanium nano host. The number of sodium alkali atoms incorporated into the germanium nano host material may be used as a parameter to tune the wavelength of optical transitions in the visible spectrum.

### Example 15

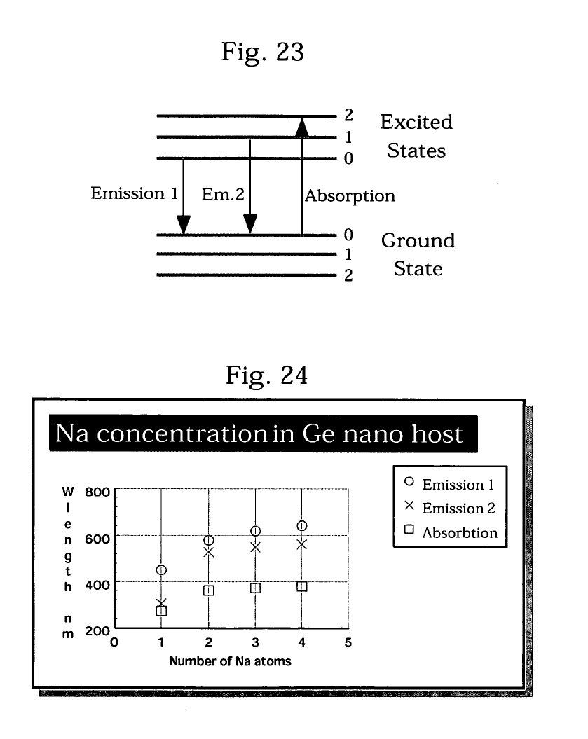

FIG. 23 is a schematic diagram of the energy levels of the nanomaterial in the present invention. The transition from excited state 0 to ground state 0 is defined as emission 1. The transition from excited state 1 to ground state 0 is defined as emission 2. The transition from ground state 0 to excited state 3 is defined as absorption. Reverse of those transitions may also occur such as in the case of a transition from ground state 0 to excited state 0. Transitions originating from lower levels of the ground state may occur as well.

Although the above examples are illustrative of computer simulations incorporating dopants into host materials, the present invention may also be performed experimentally in a chemical reaction. For example, carbon adamantane may be reacted with two sodium atoms to form sodium adamantane. The carbon may have a halogen such as Br attached.
C₁₀H₁₅Br+2Na⁺energy→NaBr+C₁₀H₁₅Na
The Br dissociates from carbon adamantane and reacts with Na to form NaBr. Excess Na in the reaction bonds to carbon adamantane. The energy required to dissociate Br can be provided by means of heat, radiation, microwaves, or electron beams.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

1. A nanomaterial comprising:
at least one host material having an optical spectrum outside of visible spectrum from about 400 nm to about 700 nm; and
at least one alkali metal dopant adjusting the optical spectrum of the host material;
wherein the nanomaterial exhibits at least one transition in the visible spectrum.

2. The nanomaterial of claim 1, wherein the at least one host material has an optical spectrum characterized by an energy band gap greater than about 3.1 eV.

3. The nanomaterial of claim 2, wherein the at least one host material has a maximum particle dimension of about 100 nm.

4. The nanomaterial of claim 3, wherein the at least one host material has a maximum particle dimension of about 10 nm.

5. The nanomaterial of claim 2, wherein the at least one alkali metal dopant is present at a concentration from about 1 to about 20 atomic percent.

6. The nanomaterial of claim 5, wherein the at least one alkali metal dopant is present at a concentration from about 5 to about 10 atomic percent.

7. The nanomaterial of claim 5, wherein the at least one host material comprises at least one of indirect semiconductor, insulator, or tricycloalkane.

8. The nanomaterial of claim 7, wherein the indirect semiconductor comprises at least one of Group IV material or Group III-V indirect semiconductor.

9. The nanomaterial of claim 8, wherein the Group IV indirect semiconductor comprises at least one of carbon, silicon, germanium, tin, or lead.

10. The nanomaterial of claim 8, wherein the Group III-V indirect semiconductor comprises at least one of boron nitride (BN), aluminum nitride (AlN), aluminum phosphide (AlP), aluminum antimonide (AlSb), or aluminum arsenide (AlAs).

11. The nanomaterial of claim 7, wherein the insulator comprises at least one of polyhedral oligomeric silsesquioxane or silicon nitride.

12. The nanomaterial of claim 7, wherein the tricycloalkane comprises at least one of carbon adamantane, silicon adamantane, or germanium adamantane.

13. The nanomaterial of claim 7, wherein the at least one alkali metal dopant comprises at least one of lithium, sodium, potassium, rubidium, cesium, or francium.

14. The nanomaterial of claim 13, wherein the at least one alkali metal dopant comprises at least one of lithium, sodium, or potassium.

15. The nanomaterial of claim 13, wherein the nanomaterial has a maximum particle dimension of about 100 nm.

16. The nanomaterial of claim 15, wherein the nanomaterial has a maximum particle dimension of about 10 nm.

17. The nanomaterial of claim 16, wherein:
the at least one alkali metal dopant is present at a concentration from about 5 to about 10 atomic percent;
the at least one host material comprises at least one of carbon, silicon, germanium, polyhedral oligomeric silsesquioxane, silicon nitride, carbon adamantane, silicon adamantane, or germanium adamantane; and
the at least one alkali metal dopant comprises at least one of lithium, sodium, or potassium.

18. The nanomaterial of claim 1 wherein:
the at least one alkali metal dopant present is at a concentration from about 5 to about 10 atomic percent; wherein
the at least one host material comprises at least one of carbon, silicon, germanium, polyhedral oligomeric silsesquioxane, silicon nitride, carbon adamantane, silicon adamantane, or germanium adamantane;
the at least one alkali metal dopant comprises at least one of lithium, sodium, or potassium; and
wherein the nanomaterial has a maximum particle size of about 10 nm.

19. A method of preparing an optically enhanced nanomaterial comprising:
combining at least one host material having an optical spectrum outside of visible spectrum from about 400 nm to about 700 nm, and at least one alkali metal dopant adjusting the optical spectrum of the host material, to obtain at least one optically enhanced nanomaterial exhibiting at least one transition in the visible spectrum.

20. The method of claim 19, wherein the at least one host material has an optical spectrum characterized by an energy band gap greater than about 3.1 eV.

21. The method of claim 19, wherein the optical spectrum of the at least one host material is adjusted by at least one of type of alkali metal dopant or concentration of alkali metal dopant present.

22. The method of claim 20, wherein the at least one host material has a maximum particle dimension of about 100 nm.

23. The method of claim 22, wherein the at least one host material has a maximum particle dimension of about 10 nm.

24. The method of claim 22, wherein the at least one alkali metal dopant is present at a concentration from about 1 to about 20 atomic percent.

25. The method of claim 24, wherein the at least one alkali metal dopant is present at a concentration from about 5 to about 10 atomic percent.

26. The method of claim 24, wherein the at least one host material comprises at least one of indirect semiconductor material, insulator, or tricycloalkane.

27. The method of claim 26, wherein the indirect semiconductor material comprises at least one of Group IV or Group III-V.

28. The method of claim 27, wherein the Group IV indirect semiconductor comprises at least one of carbon, silicon, germanium, tin, or lead.

29. The method of claim 27, wherein the Group III-V indirect semiconductor comprises at least one of boron nitride (BN), aluminum nitride (AlN), aluminum phosphide (AlP), aluminum antimonide (AlSb), or aluminum arsenide (AlAs).

30. The method of claim 26, wherein the insulator comprises at least one of polyhedral oligomeric silsesquioxane or silicon nitride.

31. The method of claim 26, wherein the tricycloalkane comprises at least one of carbon adamantane, silicon adamantane, or germanium adamantane.

32. The method of claim 26, wherein the alkali metal dopant comprises at least one of lithium, sodium, potassium, rubidium, cesium, or francium.

33. The method of claim 32, wherein the at least one alkali metal dopant comprises at least one of lithium, sodium, or potassium.

34. The method of claim 32, wherein the nanomaterial has a maximum particle dimension of about 100 nm.

35. The method of claim 34, wherein the nanomaterial has a maximum particle dimension of about 10 nm.

36. A light emitting diode comprising the nanomaterial of claim 1.

37. A light emitting diode of claim 36, wherein the nanomaterial is phosphor dispersed in a resin.

38. A light emitting diode of claim 37, wherein
the at least one alkali metal dopant is present at a concentration from about 5 to about 20 atomic percent;
the at least one host material comprises at least one of carbon, silicon, germanium, polyhedral oligomeric silsesquioxane, silicon nitride, carbon adamantane, silicon adamantane, or germanium adamantane;
the at least one alkali metal dopant comprises at least one of lithium, sodium, or potassium; and
the nanomaterial has a maximum particle size of about 10 nm.

39. A solar cell comprising the nanomaterial of claim 1.

40. The solar cell of claim 39, wherein
the at least one alkali metal dopant is present at a concentration from about 5 to about 20 atomic percent;
the at least one host material comprises at least one carbon, silicon, germanium, polyhedral oligomeric silsesquioxane, silicon nitride, carbon adamantane, silicon adamantane, or germanium adamantane;
the at least one alkali metal dopant comprises at least one of lithium, sodium, or potassium; and
the nanomaterial has a maximum particle size of about 10 nm.

41. A phosphor dispersed in a resin comprising the nanomaterial of claim 1.

42. A light absorbing layer comprising the nanomaterial of claim 1.

43. A solar cell comprising the light absorbing layer of claim 42.

44. The solar cell of claim 43, wherein:
the at least one alkali metal dopant is present at a concentration from about 5 to about 20 atomic percent;
the at least one host material comprises at least one of carbon, silicon, germanium, polyhedral oligomeric silsesquioxane, silicon nitride, carbon adamantane, silicon adamantane, or germanium adamantane;
the at least one alkali metal dopant comprises at least one of lithium, sodium, or potassium; and
the nanomaterial has a maximum particle dimension of about 10 nm.
